(19) United States
(12) Patent Application Publication
(10) Pub. No.: US 2026/0243364 A1
(43) Pub. Date: Aug. 20, 2026

(54) ACTUATOR FOR OPENING/CLOSING VALVE

(71) Applicant: BSC CO., LTD, Incheon (KR)

(72) Inventors: Jae Hyeok JANG, Seoul (KR); Seong Hyeon JANG, Yeoju-si (KR)

(21) Appl. No.: 18/878,976

(22) PCT Filed: Jul. 18, 2022
(86) PCT No.: PCT/KR2022/010476

§ 371 Date: Dec. 26, 2024

(30) Foreign Application Priority Data
Jul. 4, 2022 (KR) 10-2022-0081774

(51) Int. Cl. F16K 31/04

(52) U.S. Cl. CPC F16K 31/043

(57) ABSTRACT

The present invention relates to a valve opening/closing actuator in which components constituting an actuator are improved to be easily disassembled and assembled to reduce a maintenance cost, and a time according to the assembly of the actuator may be shortened through the improved components, and the valve opening/closing actuator is suitable for mass production to achieve increased competitiveness with other companies. An actuator 100 according to the present disclosure, which is installed inside an upper casing 110 and a lower casing 120, and includes a driving motor M on which a first worm MG is coupled on an axis, and which drives the first worm, a worm shaft 130 in which a second worm 131 is provided at one side, and a first worm wheel 134 which is installed in link with the first worm is provided at the other side, a switching lever 130 for manual switching to one side end of the worm shaft 130, a manual handle 140 for manual actuation, a valve opening/closing means 160 having a second worm wheel 162 which interlocks with the second worm 131 of the worm shaft, and installed in link with a valve at a lower end and opening/closing the valve, and a torque cam 170 installed close to an upper end of the worm shaft 130 and confirming and guiding whether the valve is opened/closed by the actuation of the worm shaft.

### TECHNICAL FIELD

The present invention relates to a valve opening/closing actuator in which components constituting an actuator are improved to be easily disassembled and assembled, and the resulting maintenance may be reduced.

### BACKGROUND ART

In general, an actuator, which is used to open and close valves such as butterfly valves and ball valves and rotational devices such as a damper, is operated by an electric signal input from the outside, and this electric signal is usually delivered through a micro switch, and the valve and the rotational device are rotated by electrically or manually within a range of about 90°, and opened and closed.

In addition, in order to prevent rotation by a reverse torque delivered from the valve, a self-locking device by a double worm gear, a manual and electric mode switching device, an overload and overcurrent protection device, a heater for preventing a condensation and condensation water, etc., are embedded in such an actuator to continuously maintain an optimal operation state.

According to Korean Patent Registration No. 10-0201246 as prior art of a conventional valve opening/closing actuator, a mode switching device of a valve opening/closing actuator, which includes a primary worm shaft 30 installed inside a body 10 of the actuator, and directly connected to a motor 20 which is a driving source, and rotates by receiving power from the motor, a handle shaft 60 horizontally supported on the body 10 and connected to an external manual handle 40, and having a fixation clutch 50 axially installed on an end portion thereof, a secondary worm shaft 80 installed coaxially with the handle shaft 60 and having a secondary worm 81 for rotating a secondary worm wheel 70, a primary worm wheel 90 axially installed on the secondary worm shaft 80 to be enabled to be idle, and engaged with the a primary worm 31, and rotating in a standstill by the motor 20, a movable clutch 100 axially installed on the secondary worm shaft 80 between the primary worm wheel 90 and the fixation clutch 50 to be movable in an axial direction, and a yoke 120 axially installed on a switching lever supported on the body 10 to be rotatable, and horizontally moving the movable clutch 100 while pivoting jointly with the switching lever 110 to selectively couple the fixation clutch 50 and the primary worm wheel 90, is configured to include a clutch holder 200 covering the movable clutch 100 and the fixation clutch 50 in an upper and lower separation type, and configured to move in an axial direction of the secondary worm along a horizontal groove 12 of a handle cover 11 coupled to the body 10 when pulling the handle to the outside in a manual mode by removing the yoke 120 and the switching lever 110, a bolt 210 in which a bolt head 211 is guided to a guide groove 104 of the movable clutch 100 through screw coupling in the clutch holder 200, a mode switching stopper 220 coupled to be axially rotatable with a screw portion 212 of the bolt 210, and seated in a direction of the secondary worm axis so as to prevent power transmission of the primary worm wheel 90 and the movable clutch 100 in the manual mode, and a torsion spring 150 seated on a screw portion of the bolt 210, having the stopper 220 in an axial direction of the secondary worm 81 in the manual mode, and providing elastic force to separate the primary worm wheel 90 and the movable clutch 100.

However, the conventional actuator has a problem in that due to complex configurations of the components, and disassembly and assembly are not easy, so the conventional actuator has a problem that the conventional actuator is not suitable for mass production.

### DISCLOSURE

### Technical Problem

The present invention is to solve problems in related art, and has the following objects.

An object of the present invention is to provide a valve opening/closing actuator in which components constituting an actuator are improved to be easily disassembled and assembled, and the resulting maintenance costs may be reduced.

Another object of the present invention is to provide a valve opening/closing actuator which may shorten a time according to assembly of the actuator through an improved component, and is suitable for mass production to achieve increased competitiveness with other companies.

### Technical Solution

In order to achieve the object, the present invention provides a valve opening/closing actuator installed inside an upper casing and a lower casing, which includes: a driving motor coupled with a first worm on an axis thereof, and driving the first worm; a worm shaft having a second worm provided at one side and a first worm wheel installed in link with the first worm, which is provided at the other side; a switching lever for manual switching to one side end of the worm shaft, and a manual handle for manual actuation; a valve opening/closing means having a second worm wheel which interlocks with a second worm of the worm shaft, and installed in link with a value on a bottom, and opening/closing the valve; and a torque cam installed close to a top of the worm shaft, and confirming and guiding whether the valve is opened/closed by actuation of a worm shaft.

The worm shaft and first and second components for rotation-driving the worm shaft are assembled by a worm shaft installation unit of the lower casing, and the worm shaft installation unit is provided in a cylindrical horizontal state by starting one end of the lower casing, and a first component is primarily assembled at one end, the worm shaft is secondarily assembled, and a second component is tertiarily assembled.

The switching lever is assembled and installed on one end of a switching shaft which is installed in link with a manual handle as a separation type.

The torque cam includes a cam body, a pin installed at the center of a top of the cam body, and a switch cam configured to be assembled in two stages to be dislocated by the pin.

The valve opening/closing means includes a body, a second worm wheel which interlocks with the second worm on an outer periphery of the body, and an assembly unit for assembling a pin to a top of the second worm wheel, and the pin is assembled through an assembly block by the assembly unit.

### Advantageous Effects

As described above, the present invention can achieve various effects including an effect in that components constituting an actuator are improved to be easily disassembled and assembled, and an effect in that a time according to actuator assembly can be shortened through the improved components, the actuator is suitable for mass production to achieve increased competitiveness with other companies, it is apparent that the present invention is very useful.

### DESCRIPTION OF DRAWINGS

FIGS. 1 to 3 are diagrams for describing a structure of a valve opening/closing actuator according to an exemplary embodiment of the present invention.

FIG. 4 is a diagram for describing an assembly structure of a worm shaft among components of the valve opening/closing actuator according to an exemplary embodiment of the present invention.

FIG. 5 is a diagram for describing an assembly structure of a switching lever among the components of the valve opening/closing actuator according to an exemplary embodiment of the present invention.

FIGS. 6 and 7 are diagrams for describing an assembly structure of a torque cam among the components of the valve opening/closing actuator according to an exemplary embodiment of the present invention.

FIGS. 8 and 9 are diagrams for describing an assembly structure of a valve opening/closing means of the valve opening/closing actuator according to an exemplary embodiment of the present invention.

### DESCRIPTION OF MAIN REFERENCE NUMERALS OF DRAWINGS

Hereinafter, an exemplary embodiment of the present invention will be described with reference to the accompanying drawings.

Hereinbelow, in describing the present invention, detailed description of associated known function or constitutions will be omitted if it is determined that they unnecessarily make the gist of the present invention unclear. In addition, terms described later are the terms set in consideration of a function in the present invention, and these terms may vary depending on the intentions or customs of producers who produce the product, and the definitions of the terms should be based on the contents of the entire statement.

First, a large feature of an actuator 100 is that the actuator is installed inside an upper casing 110 and a lower casing 120, and the actuator 100 includes a driving motor M on which a first worm MG is coupled on an axis, and which drives the first worm, a worm shaft 130 in which a second worm 131 is provided at one side, and a first worm wheel 134 which is installed in link with the first worm is provided at the other side, a switching lever 150 for manual switching to one side end of the worm shaft 130, a manual handle 140 for manual actuation, a valve opening/closing means 160 having a second worm wheel 162 which interlocks with the second worm 131 of the worm shaft, and installed in link with a valve at a lower end and opening/closing the valve, and a torque cam 170 installed close to an upper end of the worm shaft 130 and confirming and guiding whether the valve is opened/closed by the actuation of the worm shaft.

In addition, the worm shaft 130, and first and second components 132 and 133 for rotation driving of the worm shaft are assembled by a worm shaft installation unit 121 of the lower casing 120, and the worm shaft installation unit 121 is provided in a cylindrical horizontal starting one end of the lower casing 120, and is configured so that a first component 132 is primarily assembled at one end, the worm shaft is secondarily assembled, and a second component 133 is tertiarily assembled.

Further, the switching lever 150 is assembled and installed on one end of a switching shaft 151 which is installed in link with the manual handle 140 by a bolt B as a separation type.

In addition, the torque cam 170 is constituted by a cam body 171, a pin 172 installed at a center of a top of the cam body, and switch cams 173 assembled and configured in two stages to be dislocated by the pin 172.

The valve opening/closing means 160 is constituted by a body 161, a second worm wheel 162 which interlocks with the second worm 131 on an outer periphery of the body, and an assembly unit 163 for assembling a pin 164 to a top of the second worm wheel, so the pin is assembled through an assembly block 165 by the assembly unit 163.

Hereinafter, the present invention will be described in more detail with reference to the accompanying drawings.

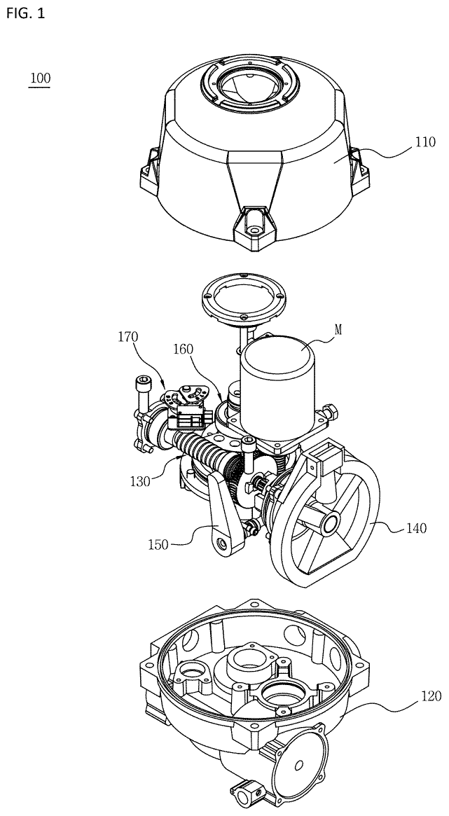

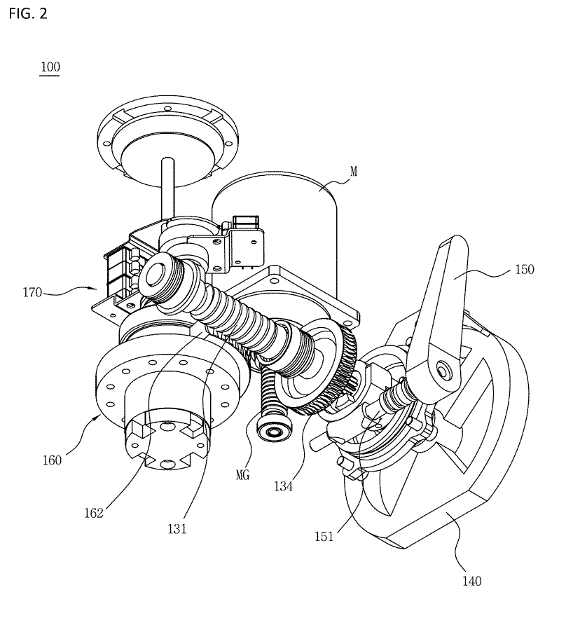

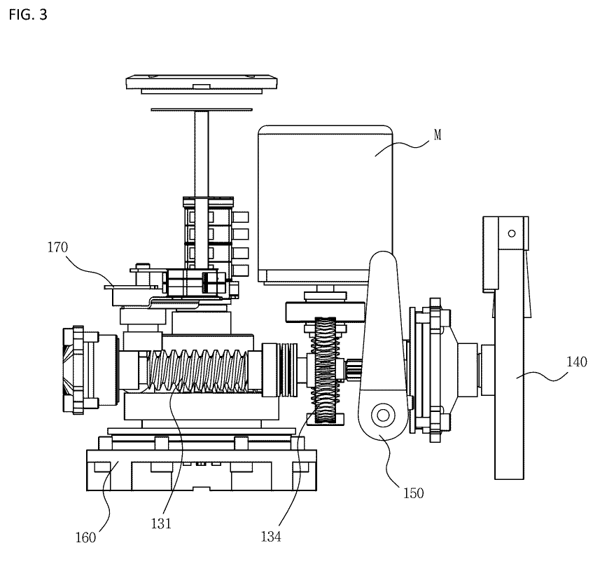

FIGS. 1 to 3 which are the accompanying drawings are diagrams for describing a structure of a valve opening/closing actuator according to an exemplary embodiment of the present invention.

The actuator 100 of the present invention is constituted by the upper casing 110 and the lower casing 120 which are separable, and the driving motor M is embedded inside the upper and lower casings, and a first worm MG is configured on an axis of the driving motor to be rotated by actuation of the driving motor.

In addition, the worm shaft 130 is installed in link with the first worm.

The first worm wheel 134 which interlocks with the first worm is provided on the worm shaft 130, the second worm 131 is provided at the other end, and the switching lever 150 for not electric but manual switching is provided at one end of the first worm wheel, and the manual handle 140 for manual actuation according to switching of the switching lever is provided.

In addition, the torque cam 170 for detecting and confirming whether the valve is opened/closed by rotation driving of the worm shaft is provided on the top of the worm shaft 130.

Further, the valve opening/closing means 160 is provided at a rear end portion of the worm shaft, and the second worm wheel 162 is provided in the valve opening/closing means and the second worm wheel is installed in link with the second worm 131 of the worm shaft.

That is, the first worm MG is rotated and driven by driving the driving motor M, and the first worm wheel 134 which is engaged with the first worm MG rotates and the entire worm shaft 130 is rotated and driven, and the valve opening/closing means 160 is driven by driving the second worm wheel 162 engaged with the second worm 131, and opening/closing of the valve which interlocks with the valve opening/closing means 160 is made.

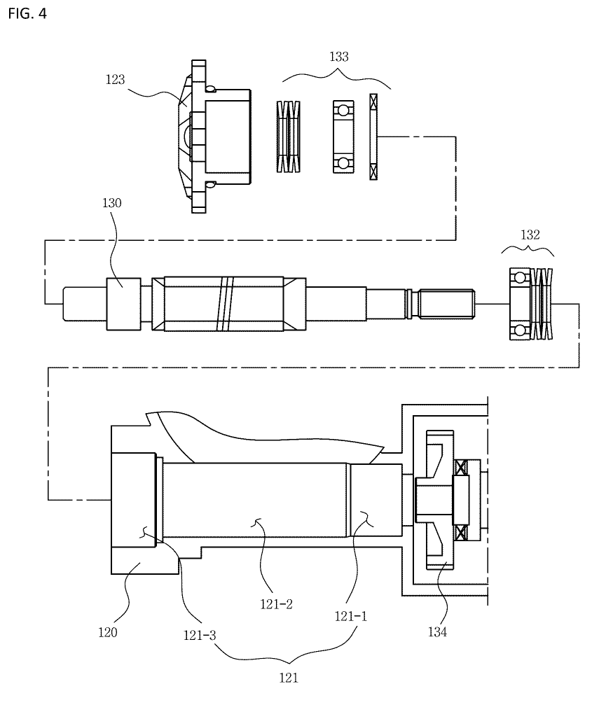

FIG. 4 is a diagram for describing an assembly structure of a worm shaft among components of the valve opening/closing actuator according to an exemplary embodiment of the present invention.

The worm shaft 130 is installed in the worm shaft installation unit 121 provided in the lower casing 120, and the worm shaft installation unit 121 is configured to be parallel by starting opening at one side.

The first component 132 supporting the worm shaft is primarily assembled at one end of the worm shaft installation unit 121 which is configured in parallel, and then the worm shaft 130 is secondarily assembled, and the second component 133 is assembled, and a cap 123 which protects the worm shaft is assembled.

As described above, the first component 132 and the worm shaft 130 at one direction, and the second component 133 may be assembled, so the time according to the assembly is shortened, and it is easy to replace a worn or broken part.

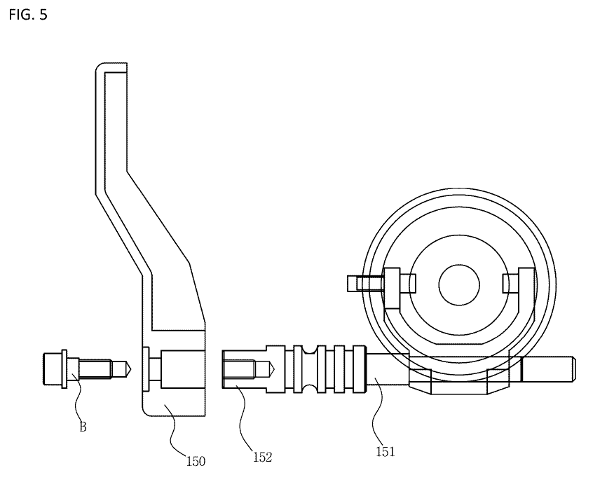

FIG. 5 is a diagram for describing an assembly structure of a switching lever among the components of the valve opening/closing actuator according to an exemplary embodiment of the present invention.

The conventional switching lever 150 as an integrated type in which a level handle and a switching shaft are bent has a problem in that there is inconvenience and degraded productivity, but the switching lever 150 according to the present invention as a separation type of a switching shaft 151 and a switching lever 150 has an advantage in that assemblability is excellent and it is convenient to replace a part.

That is, each of the switching shaft 151 and the switching lever 150 is configured to be separated, and the switching lever is assembled to one installation unit 152 of the switching shaft and is formed in a structure in which the switching lever is fixedly installed through the bolt B.

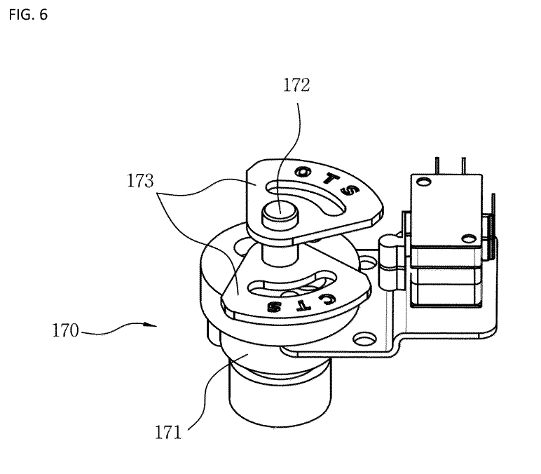

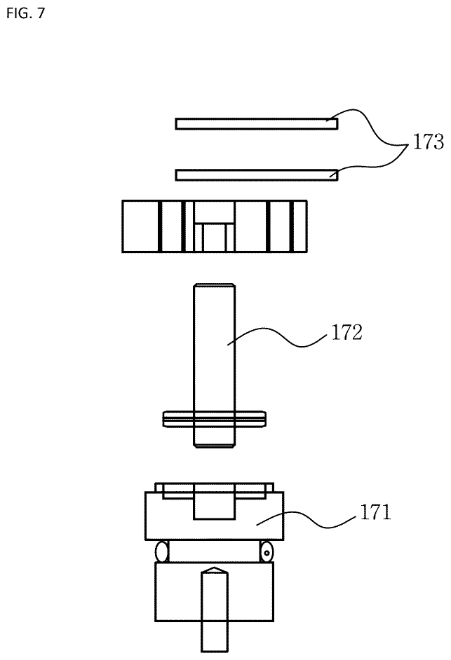

FIGS. 6 and 7 are diagrams for describing an assembly structure of a torque cam among the components of the valve opening/closing actuator according to an exemplary embodiment of the present invention.

The torque cam 170 according to the present invention is configured a cam body 171 and a pin 172 on a top of the cam body, and switch cams 173 are structured to be assembled in two stages at an upper portion of the pin 172.

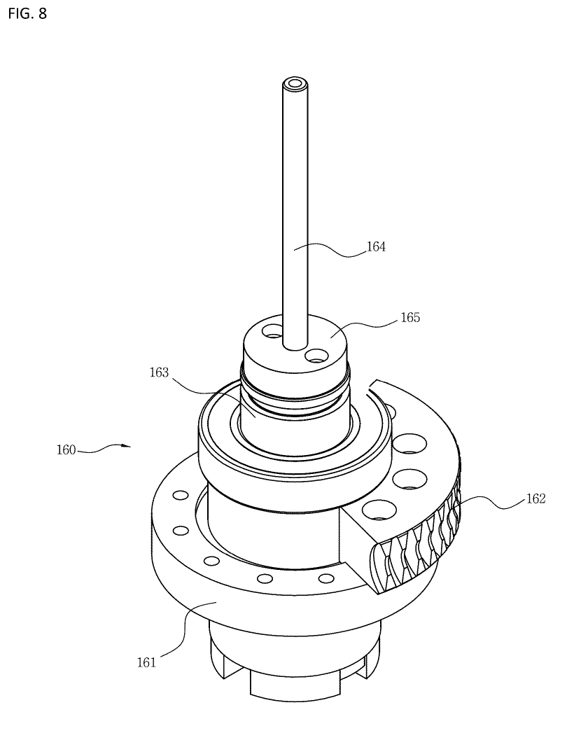

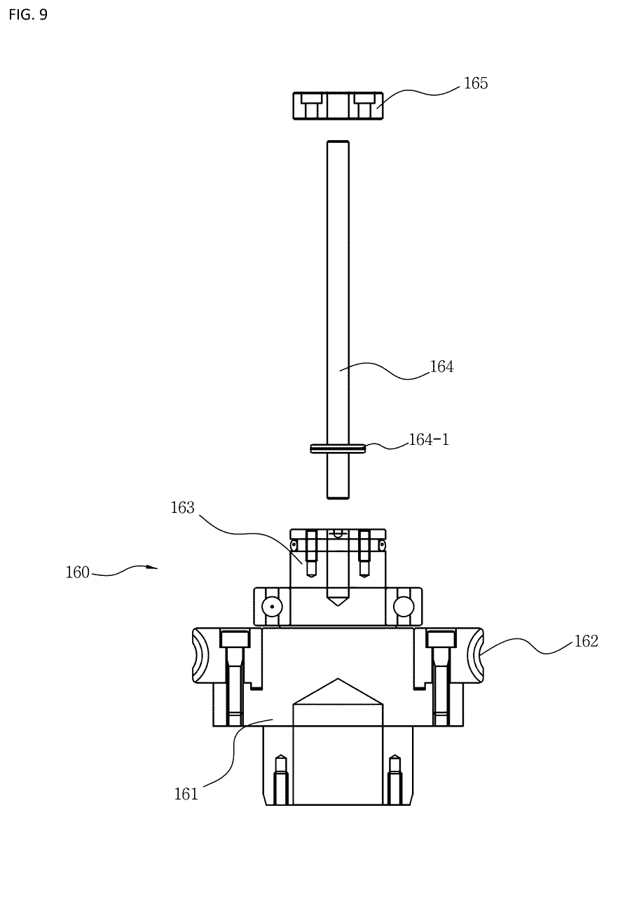

FIGS. 8 and 9 are diagrams for describing an assembly structure of a valve opening/closing means of the valve opening/closing actuator according to an exemplary embodiment of the present invention.

The valve opening/closing means 160 according to the present invention includes a body 161 and a second worm wheel 162 engaged with the second worm 131 on an outer periphery of the body, and an assembly unit 163 capable of assembling a pin is provided on a top of the valve opening/closing means 160, so a pin 164 is assembled through an assembly block 165.

In addition, it is preferable that a connection body connected to a valve body is configured on the bottom of the body 161 to be installed to interlock with the valve body.

As described above, the present invention has an advantage in that the components constituting the actuator are improved to be simply disassembled and assembled, thereby reducing maintenance costs.

Further, there is an advantage in that the time according to the assembly of the actuator can be shortened through the improved component, and the actuator is suitable for mass production to achieve increased competitiveness with other companies.

1. A valve opening/closing actuator installed inside an upper casing 110 and a lower casing 120, comprising:
a driving motor M coupled with a first worm MG on an axis thereof, and driving the first worm;
a worm shaft 130 having a second worm 131 provided at one side and a first worm wheel 134 installed in link with the first worm, which is provided at the other side;
a switching lever 150 for manual switching to one side end of the worm shaft 130, and a manual handle 140 for manual actuation;
a valve opening/closing means 160 having a second worm wheel 162 which interlocks with a second worm 131 of the worm shaft, and installed in link with a value on a bottom, and opening/closing the valve; and
a torque cam 170 installed close to a top of the worm shaft 130, and confirming and guiding whether the valve is opened/closed by actuation of a worm shaft

2. The valve opening/closing actuator of claim 1, wherein the worm shaft 130 and first and second components 132 and 133 for rotation-driving the worm shaft are assembled by a worm shaft installation unit 121 of the lower casing 120, and
the worm shaft installation unit 121 is provided in a cylindrical horizontal state by starting one end of the lower casing 120, and a first component 132 is primarily assembled at one end, the worm shaft is secondarily assembled, and a second component 133 is tertiarily assembled.

3. The valve opening/closing actuator of claim 1, wherein the switching lever 150 is assembled and installed on one end of a switching shaft 151 which is installed in link with a manual handle 140 by a bolt B as a separation type.

4. The valve opening/closing actuator of claim 1, wherein the torque cam 170 includes
a cam body 171,
a pin 172 installed at a center of a top of the cam body, and
a switch cam 173 configured to be assembled in two stages to be dislocated by the pin 172.

5. The valve opening/closing actuator of claim 1, wherein the valve opening/closing means 160 includes
a body 161,
a second worm wheel 162 which interlocks with the second worm 131 on an outer periphery of the body, and
an assembly unit 163 for assembling a pin 164 to a top of the second worm wheel, and
the pin is assembled through an assembly block 165 by the assembly unit 163.
